(19) United States
(12) Patent Application Publication
(10) Pub. No.: US 2008/0055477 A1
(43) Pub. Date: Mar. 6, 2008

(54) Method and System for Motion Compensated Noise Reduction

(76) Inventors: Dongsheng WU, Hainesport, NJ (US); Philip SWAN, Richmond Hill (CA); Richard SITA, Audubon, NJ (US); Paul GEHMAN, Doylestown, PA (US); Ankur JAIN, Bensalem, PA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/847,820

(22) Filed: Aug. 30, 2007

Related U.S. Application Data
(60) Provisional application No. 60/824,191, filed on Aug. 31, 2006.

(51) Int. Cl. H04N 5/00

(52) U.S. Cl. 348/620

(57) ABSTRACT

The present invention is directed to a method and system for improved motion compensated noise reduction. The system uses a temporal noise reduction filter to remove noise from the current input field and pass it through a de-interlacer to produce a noise reduced full output frame. The temporal noise reduction filter reduces noise in the present field by blending it with a predicted (motion compensated) field determined from the immediately preceding full output frame. In accordance with the invention where the current input field is for time or sequence n, the motion compensated field can be determined from the output frame corresponding to time or sequence n−1. In addition, the motion compensated field can be predicted using motion estimation and motion compensation using the current input field and the previous output frame. By using the previous de-interlaced frame which includes the information for both field polarities, the vertical resolution of the motion estimation process can be improved.

### CROSS-REFERENCE TO RELATED APPLICATIONS

This application claims any and all benefits as provided by law of U.S. Provisional Application No. 60/824,191 filed Aug. 31, 2006 which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

This invention relates to the field of video signal processing and to methods and systems for providing temporal noise reduction and motion compensation and motion estimation processing.

2. Description of the Prior Art

Random noise can be a major impairment in video signals. Such noise may degrade video quality and affect subsequent video coding operations. Noise reduction algorithms can improve visual quality by removing noise from the video signal. In addition, noise reduction can enable better coding or compression of video signals, because bits may be used to code the signal itself rather than to code the noise.

Sources of noise may include radio-frequency (RF) noise, jitter, and picture noise such as film grain. The RF noise typically has a Gaussian distribution. It may be desirable to remove effects of RF noise from a video signal without unduly affecting aesthetic features such as film grain noise.

One method of removing random noise is called Temporal Noise Reduction. This method takes advantage of the inherent property of the random noise to change over time to reduce noise while maintaining the sharpness of the video content. Usually, it works perfectly well for still images. The inconsistencies between multiple images are simply removed, leaving the clean signal of the objects in the video.

Unfortunately, the processing of the moving objects can be considerably more difficult. By eliminating inconsistencies between multiple images, motion estimation technology may unintentionally blur parts of the moving object that repositioned from one frame to the next. This can often result in what is known as a “Ghost” effect.

A more effective method of noise reduction for video segments with moving objects is called motion compensated noise reduction (“MCNR”). MCNR is a temporal noise reduction technology that is capable of reducing noise without sacrificing the details for content in motion by using motion estimation and motion compensation (“MEMC”) techniques.

One form of temporal noise reduction is the motion-adaptive filtering technique which averages all or part of the current video frame with corresponding portions of one or more adjacent frames based on detected motion. According to this technique, temporal filtering may be suspended for a portion of the current field or frame, which differs by more than a threshold value from a corresponding portion of another field or frame.

Another form of temporal noise reduction is a motion-compensated filtering technique which compares the corresponding blocks of adjacent video frames by taking into account the motion vector of one of the corresponding blocks. The motion vector of a block can be estimated using the MEMC techniques. One MEMC technique is block matching which provides a measure of comparison of pixel values using a SAD (sum of absolute difference) algorithm. Another MEMC technique uses phase-plane correlation based algorithms.

Broadcast video may be generated from video and film sources. Interlacing technology can provide acceptable picture quality in a video transmission within the available bandwidth. Interlacing generally involves a two-step process. First, each video frame is subdivided into 2 fields—one composed of every odd line of the frame and another composed of every even line of the frame. Second, each field in the video signal is formed from either the even lines of the frame or the odd lines of the frame, transmitted in the alternating manner.

In this form of prior art motion compensated noise reduction, motion vectors for the current field are predicted from one or more odd reference fields when the current field is an odd field, and motion vectors for the current field are predicted from one or more even reference fields when the current field is an even field. In one example, the block sizes used are Nₓ=N_{y}=8 pixels for progressive prediction and Nₓ=8, N_{y}=16 pixels for interlaced prediction (using frame coordinates). Typically a search window with size of −8≦Wₓ≦7.5 and −8≦W_{y}≦7.5 is enough to track desirable motion. Embodiments may be configured for application to any other values of Nₓ, N_{y}, Wₓ, and/or W_{y}.

FIG. 1 shows a block diagram of a prior art system 100 for performing temporal noise reduction on an interlaced video signal. In this system, the interlaced video signal is processed using both a temporal noise reduction filter 110 and an MEMC module 120. In system 100, the current input field IFieldₙ(x,y) contains random noise to be removed by the temporal noise reduction filter 110. The temporal noise reduction filter 110 removes noise from the current input field IFieldₙ(x,y) by blending it with a motion-compensated field MFieldₙ(x,y) generated by the MEMC 130. The MEMC 130 takes as input, the current input field IFieldₙ(x,y) and the past clean (noise reduced) field OFieldₙ₋₂(x,y) and uses motion estimation and motion compensation to produce the motion-compensated field MFieldₙ(x,y). The MEMC 130 determines the motion vectors for the current input field IFieldₙ(x,y) relative to the past clean field OFieldₙ₋₂(x,y) and generates the motion-compensated field MFieldₙ(x,y) by applying those motion vectors to the past clean field OFieldₙ₋₂(x,y). The output clean field OFieldₙ(x,y) is then input to a De-interlacer 120 which de-interlaces the signal, using the output clean field OFieldₙ(x,y) to produce an output clean frame OFrameₙ(x,y)

The temporal noise reduction filter 110 can blend the current noisy field with the past cleaned field using a blending ratio or proportion. The blending proportion can be selected so that the sum of the two blending coefficients is equal to 1. This can be done, for example, to keep the nature of the signal unchanged.

In the prior art, the motion-compensated field MFieldₙ(x,y) must be generated from a field that is the same polarity as the current input field IFieldₙ(x,y) in order for the motion estimation and motion compensation process to be effective. This requirement adds complexity to the system as it is required to maintain copies of the last two frames processed. In addition, this can cause motion errors as moving objects will appear further apart then in the sequence of frames, potentially making the job of the MEMC module more difficult.

### SUMMARY

The present invention is directed to methods and systems for noise reduction of an interlaced video signal that includes a plurality of interlaced fields. The video signal can be received from a video source or received from a memory device that stores the video signal in a digital format. The method includes receiving noisy current interlaced fields and using temporal noise reduction to remove noise in the noisy current interlaced fields based on a reference frame, wherein the reference frame is determined as a function of a prior clean deinterlaced frame. The reference frame can be processed using motion estimation or motion compensation based on the current field. The prior clean deinterlaced frame used to generate the reference field can be the frame corresponding to the position immediately prior to the current field.

The present invention further provides a method for motion estimation and motion compensation (“MEMC”) of blocks in the interlaced video signal. In one embodiment of the present invention, the MEMC module can receive a noisy interlaced input field. The input field can correspond to a particular field position, such as the current field position. The MEMC module can also receive a deinterlaced frame, generated as a function of the previous clean field. The deinterlaced frame can be used as a reference for motion estimation and motion compensation of the noisy input field. In other embodiments, the MEMC module can also receive a deinterlaced frame, generated as a function of any previous noisy input field. The MEMC module can provide a motion compensated reference field or reference frame to the temporal noise reduction module and the temporal noise reduction module can use the reference field or reference frame to reduce noise in the input field.

A system according to the present invention can include a motion estimation and motion compensation module adapted to produce a motion compensated field as a function of the input field and a de-interlaced frame. The de-interlaced frame corresponds to a field position that is prior to the field the position of the input field. In one embodiment, the field position of the de-interlaced frame can correspond to the field position immediately prior to the field position of the input field. In other embodiments, de-interlaced frames corresponding to other prior fields (i.e., n−2, n−3, etc.) can be used. The system can also include a noise reduction filter adapted to reduce noise in the input field as a function of the motion compensated field. In one embodiment, the motion compensated field can be blended with the input field to produce a noise reduced input field. In other embodiments, other signal processing operations can be applied to the input field to reduce noise using the motion compensated field. The system can also include a de-interlacer adapted to produce a de-interlaced output frame using the noise reduced input frame. The de-interlaced output frame can be output to a storage device or to a video display. The de-interlaced output frame can also be fed back to the motion compensation and motion estimation module for use in producing subsequent motion compensated frames which can be used by the noise reduction filter to remove noise from subsequent input frames.

The present invention also provides a method for performing temporal noise reduction by using the output of the motion estimation and motion compensation module that performed the calculations for blocks in the interlaced video signal using the deinterlaced frame as a reference.

These and other capabilities of the invention, along with the invention itself, will be more fully understood after a review of the following figures, detailed description, and claims.

### BRIEF DESCRIPTION OF THE FIGURES

FIG. 1 shows a diagram representing a prior art system for a temporal noise reduction on an interlaced signal;

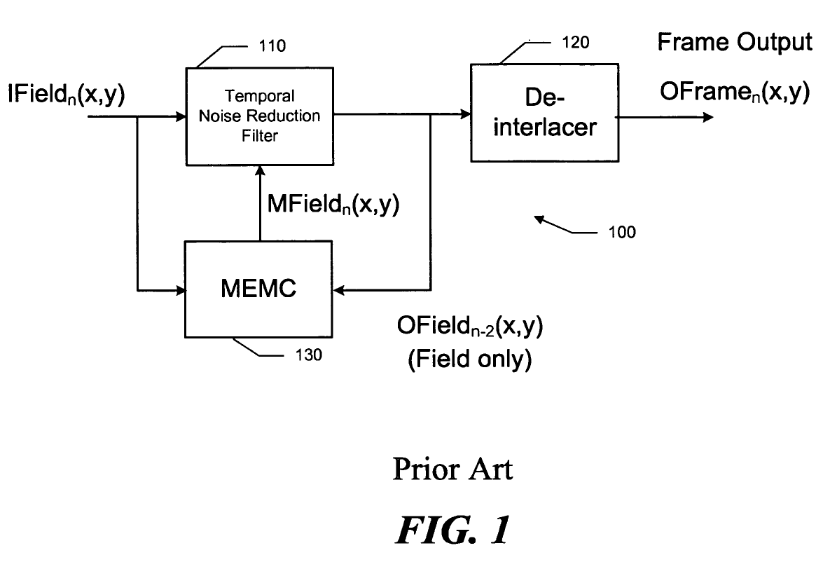

FIG. 2 shows a block diagram representing the present invention system for a temporal noise reduction on an interlaced signal;

FIG. 3 shows a diagram for the motion compensated block matching for the interlaced video signal; and

FIG. 4. shows a flow chart of a method for noise reduction according to the present invention.

### DETAILED DESCRIPTION OF PREFERRED EMBODIMENTS

The present invention is directed to a method and system for noise reduction of an interlaced video signal. In accordance with the invention, an input video stream comprising a plurality of interlaced video fields is processed to remove noise and de-interlace the video stream to product a plurality of video frames. The input video stream can be an analog or digital video signal that is received from a video source or a digital video signal retrieved from a memory device, such as a random access memory (RAM) or a read only memory (ROM, CD-ROM, DVD, etc). The method according to the invention includes applying a temporal noise reduction filter to the input fields to produce a stream of clean (noise reduced) output fields and then using clean output fields to produce a stream of clean output deinterlaced video frames. In accordance with the invention, the temporal noise reduction filter can use a motion-compensated field derived from a past clean frame that has been motion compensated to the current field position in a process that removes or reduces temporal noise in an input field. More accurate noise reduction can be accomplished by using an immediately prior clean frame as the basis for noise reduction although frames corresponding to other prior frame positions (e.g. n−2 and prior) can be used.

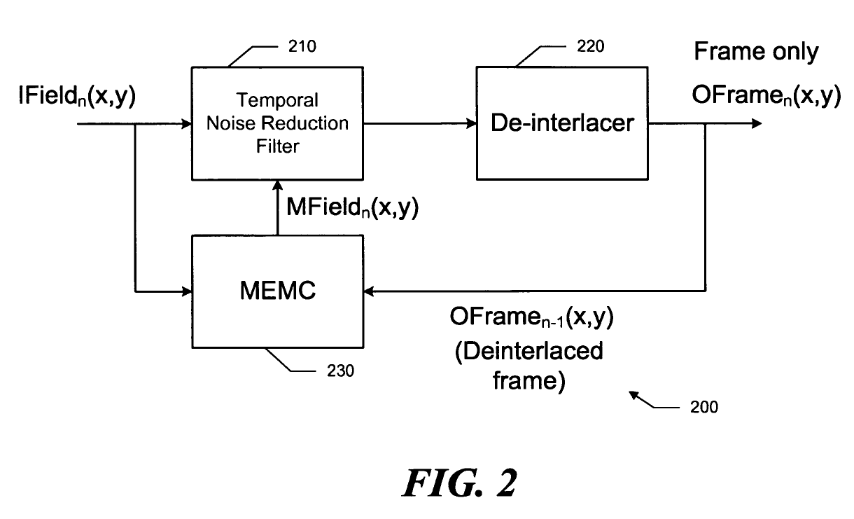

FIG. 2 illustrates one embodiment of the system 200 according to the present invention. This system 200 includes a noise reduction module, such as a temporal noise reduction (“TNR”) filter 210, a motion estimation motion compensation (MEMC) module 230 and a deinterlacer module 220. In system 200, the current input field IFieldₙ(x,y) contains random noise to be removed by the temporal noise reduction filter 210. The temporal noise reduction filter 210 can remove noise from the current input field IFieldₙ(x,y) by blending it with a motion-compensated field MFieldₙ(x,y) generated by the MEMC 230. The MEMC 230 takes as input the current input field IFieldₙ(x,y) and the past clean (noise reduced) frame OFrameₙ₋₁(x,y) output from the deinterlacer module 220 and uses motion estimation and motion compensation to produce the motion-compensated field MFieldₙ(x,y). The MEMC 230 determines the motion vectors for the current input field IFieldₙ(x,y) relative to the past clean field OFrameₙ₋₁(x,y) and generates the motion-compensated field MFieldₙ(x,y) by applying those motion vectors to the past clean field OFrameₙ₋₁(x,y). The output clean field OFieldₙ(x,y) can be input to a De-interlacer 120 which de-interlaces the signal, using the output clean field OFieldₙ(x,y) to produce an output clean frame OFrameₙ(x,y). The output clean frame OFrameₙ(x,y) can be fed back to the MEMC 230 to become output clean frame OFrameₙ₋₁(x,y) for the subsequent current input field IFieldₙ(x,y).

The TNR filter 210 can remove random noise from the video signal. The TNR filter 210 takes advantage of the inherent property of random noise in the video signal, that the noise will not be the same from field to field or frame to frame and that it will change over time. By blending adjacent fields in the video signal to each other, the TNR filter 210 can reduce random noise.

According to the present invention, the TNR filter 210 input signal input field IFieldₙ(x,y) consists of a stream of interlaced fields, where n indicates the number or sequence of the field. The stream of interlaced fields can be received in a video signal from a video source or received from a memory device, such as a random access memory (RAM), a read only memory (ROM, CD-ROM, DVD-ROM), or an optical or magnet memory device. The TNR filter 210 can remove or reduce the noise from these fields by blending the current noisy field with the past clean field. This operation resembles the IIR (infinite impulse response) filter in the temporal domain. The TNR filter 210 can remove the noise from the input fields by using motion-compensated fields. The motion-compensated fields used by the TNR 210 can be generated by the MEMC module 230 from the immediately prior (n−1) clean frame. The immediately prior clean frame can be the frame produced from the deinterlacer 220 using the immediately prior (n−1) clean field in the sequence of fields relative to the current field (n).

According to the present invention, the TNR 210 can reduce the noise in the noisy field by blending the noisy field with a cleaned field generated from an immediately prior (n−1) clean frame. In one example, the blending coefficient can be equal to 1, so that the nature of the signal remains unchanged. In one embodiment, the output of the TNR filter 210 is a clean interlaced field. Alternatively, the TNR filter 210 can reduce the noise in the current input field using other known techniques for removing random noise based on prior field or frame information.

The MEMC module 230 can determine the motion vectors for the present field and apply those motion vectors to a prior field or frame in order to produce a motion compensated field or frame.

In one embodiment of the present invention, the MEMC module 230 can provide the motion vector information, and use this information to adjust the position of the objects in the prior clean frame to the corresponding position in the current noisy field. The output of the MEMC module 230 can be a motion compensated field adjusted using the motion vectors determined from the present field (n) and the frame produced from the immediately prior field (n−1) in the sequence of fields.

The deinterlacer 220 can process the interlaced video signal which is made up of a sequence of fields and convert this signal into a deinterlaced video signal which is made up of a sequence of frames. Interlaced video signals are made up of odd and even fields that can only provide half of the data of a complete frame. Various deinterlacing techniques can be used to produce the full frame from the odd and even fields. These interlacing techniques can include weaving, blending, selective blending, half sizing, and link doubling.

As shown in FIG. 2, the deinterlacer 220 receives the clean field from the TNR filter 210 and generates a deinterlaced frame. This deinterlaced frame is sent back in the feedback loop to the MEMC module 230. The MEMC module 230 uses the deinterlaced frame received from the deinterlacer module 220 as a reference for the motion estimation motion compensation calculations. This deinterlaced frame calculated by the deinterlacer module 220 is also used as the output of the motion compensation noise reduction system according to the invention.

One of the advantages of present invention is that because a full frame can provide better vertical resolution than a field (which only contains half the frame information), the motion compensation processing is improved.

In accordance with the invention, the MEMC 230 can use a frame that is closer in time or sequence to the present field to generate the motion compensated field. This can provide more accurate motion estimation and compensation than a frame or a field that more distant in the past or sequence of fields. This approach also can reduce the processing latency and therefore provide more accurate motion estimation and motion compensation.

In accordance with the invention, when the TNR filter 210 is processing field n, the reference frame can be determined from frame n−1. The shorter time between the field positions of the input field and the reference frame can improve the quality of the motion estimation and motion compensation processing.

In one embodiment, the de-interlacer can duplicate the previous field for use in generating the output frame. The duplication of previous field could also duplicate the noise. In an alternative embodiment, the same architecture of MEMC 230 can be used to determine the reference frame from frame n−2 when the TNR filter 210 is processing field n.

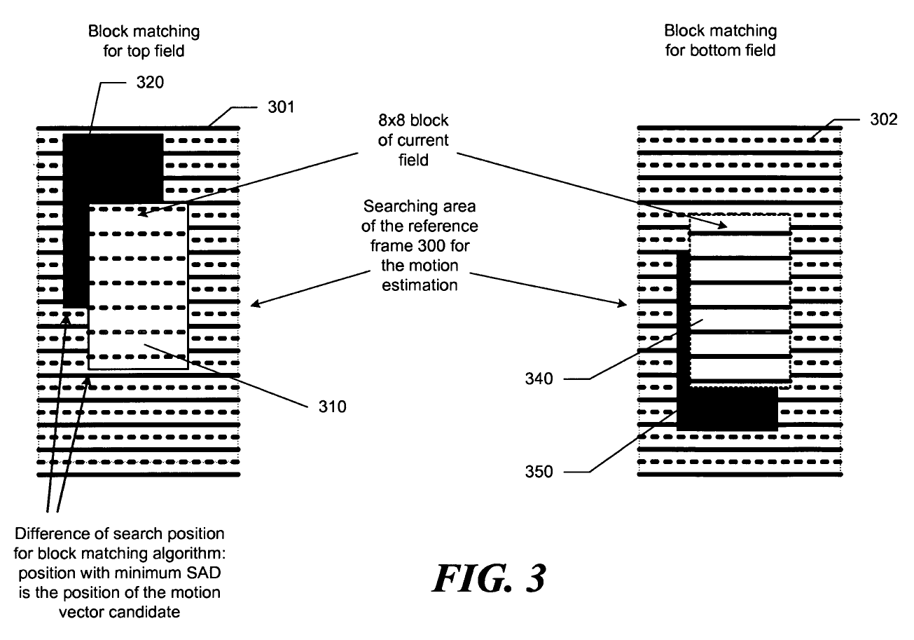

FIGS. 3A and 3B illustrate a process for field block matching in a reference frame according to the invention. FIG. 3A illustrates block matching for a top field or odd field and FIG. 3B illustrates block matching for a bottom field or even field. In accordance with invention, the past clean frame serves as the reference frame for matching a block from the current (noisy) field. In one embodiment of the invention, the block 310 to be matched is an 8×8 pixel block from the present field, which can be a top field or a bottom field.

According to the invention, the MEMC module 230 determines the location of the block 310 in the reference frame 300. The reference frame 300 contains the pixel information corresponding to the top fields 301 (shown by the dotted lines) and to the bottom fields 302 (shown by the solid lines). The location of the corresponding matching block in the reference frame 300 is illustrated as top matching block 320 and bottom matching block 350. The MEMC module 230 further determines the motion vector that represents the motion from the position of the top matching block 320 in the reference frame 300 to the position of the top field block 310 in the noisy top field and the position of the bottom matching block 350 in the reference frame 300 to the position of the bottom field block 340 in the noisy bottom field. This vector can be determined using a SAD (sum of absolute differences) algorithm or a phase correlation block matching algorithm. Since the reference frame 300 contains the full frame information, the block comparison algorithm can match the top field block 310 or the bottom field block 340 (which contains only top field or bottom field information) to the full frame which contains the information for both field polarities and produce improved motion vectors that have improved resolution in the vertical direction.

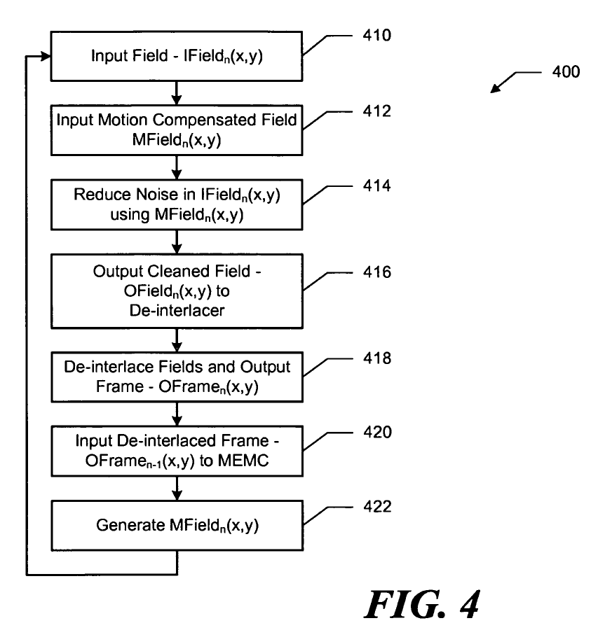

FIG. 4 shows a diagram of a process 400 for reducing noise according to the invention. At step/operation 410, the TNR filter 210 receives the current input field IFieldₙ(x,y) that contains random noise to be removed. From step/operation 420, the previous output frame OFrameₙ₋₁(x,y) to the current field (field n) can be input to the MEMC 230 and at step/operation 422, the previous output frame OFrameₙ₋₁(x,y) can be used to produce the clean motion compensated field MFieldₙ(x,y) for use in reducing noise in the succeeding field. At step/operation 412, the TNR filter 210 receives clean motion compensated field MFieldₙ(x,y) generated by the MEMC 230. At about the same time, the MEMC 230 receives as input, the current input field IFieldₙ(x,y) and the past clean (noise reduced) frame OFrameₙ₋₁(x,y) output from the deinterlacer module 220 and uses motion estimation and motion compensation to produce, as described herein, the motion-compensated field MFieldₙ(x,y). At step/operation 414, the TNR filter 210 processes the current input field IFieldₙ(x,y) using the clean motion compensated field MFieldₙ(x,y) generated by the MEMC 230 to produce a clean current output field OFieldₙ(x,y). At step/operation 416, the clean current output field OFieldₙ(x,y) is input to the de-interlacer 220. At step/operation 418, the de-interlacer 220 de-interlaces the field and produces a full clean frame, current output frame OFrameₙ(x,y). At step/operation 420, the current output frame OFrameₙ(x,y), becomes the prior (n−1) frame (OFrameₙ₋₁(x,y)) to the current field (field n) and is input to the MEMC 230 and at step/operation 422, OFrameₙ₋₁(x,y) can be used to produce the clean motion compensated field MFieldₙ(x,y) for use in reducing noise in the succeeding field. The process can return to step/operation 412 to process the next field. As one ordinary skill would appreciate, the steps/operations of the process need not be completed in the order shown in FIG. 4. For example, the input field IFieldₙ(x,y) and the motion-compensated field MFieldₙ(x,y) can be input into the TNR filter 210 in any order or at the same time. The motion-compensated field MFieldₙ(x,y) can be generated from the output frame OFrameₙ₋₁(x,y) before after the input field IFieldₙ(x,y) is received by the TNR filter 210.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for motion compensated noise reduction of an input signal, the input signal comprising a plurality of input fields, the system comprising:
a motion estimation and motion compensation module adapted to produce a motion compensated field corresponding to an input field as a function of the input field corresponding to a first field position and a de-interlaced frame corresponding to a previous field position; and
a noise reduction filter adapted to produce a noise reduced output field as a function of the input field and the motion compensated field.

2. A system according to claim 1 wherein the input field is the current field corresponding to the current field position.

3. A system according to claim 1 wherein the de-interlaced frame corresponds to the field position immediately preceding the field position of the input field.

4. The system according to claim 1 further comprising:
a de-interlacer adapted to produce a noise reduced de-interlaced output frame as a function of the noise reduced output field.

5. The system according to claim 4 wherein said noise reduced de-interlaced output frame is fed back to said motion estimation and motion compensation module for use in generating a motion compensated field corresponding to a subsequent field position.

6. The system according to claim 1 wherein the noise reduction filter is a temporal noise reduction filter.

7. The system according to claim 1 wherein the noise reduction filter removes random noise from the input signal.

8. The system according to claim 1 wherein the noise reduction filter removes noise by blending the input field corresponding to the first field position and the motion compensated field corresponding to the input field.

9. The system according to claim 8 wherein the noise reduction filter uses a blending coefficient equal to 1.

10. A method for motion compensated noise reduction of an input signal, the input signal comprising a plurality of input fields, the method comprising:
producing a motion compensated field corresponding to an input field as a function of the input field corresponding to a first field position and a de-interlaced frame corresponding to a previous field position; and
applying a noise reduction filter to produce a noise reduced output field corresponding to the first field position as a function of the input field and the motion compensated field corresponding to the current field position; and
outputting the noise reduced output field for use in storing or displaying a video signal.

11. The method according to claim 10 wherein the input field is the current field corresponding to the current field position.

12. The method according to claim 10 wherein the de-interlaced frame corresponds to the field position immediately preceding the field position of the input field.

13. The method according to claim 10 further comprising:
de-interlacing the noise reduced output field to produce a noise reduced de-interlaced output frame.

14. The method according to claim 13 wherein said noise reduced de-interlaced output frame is used for generating a motion compensated field corresponding to a subsequent field position.

15. The method according to claim 10 wherein the noise reduction filter is a temporal noise reduction filter.

16. The method according to claim 10 wherein the noise reduction filter removes random noise from the input signal.

17. The method according to claim 10 wherein the noise reduction filter removes noise by blending the input field corresponding to the first field position and the motion compensated field corresponding to the input field.

18. The method according to claim 17 wherein the noise reduction filter uses a blending coefficient equal to 1.

19. A video signal processing device comprising:
a motion estimation and motion compensation module adapted to produce a motion compensated field corresponding to an input field as a function of the input field and a de-interlaced frame, the de-interlaced frame corresponding to a field position prior to a field position of the input field;
a noise reduction filter adapted to produce a noise reduced output field as a function of the input field and the motion compensated field; and
a de-interlacer adapted to produce a noise reduced de-interlaced output frame as a function of the noise reduced output field.

20. A method for noise reduction of an input field, the method comprising:
generating a motion compensated frame as a function of the input field and a noise reduced frame;
applying the input field to a temporal noise reduction filter to reduce the noise in the input field as a function of the motion compensated frame to produce a noise reduced output field; and
applying the noise reduced output field to a deinterlacer for generating a noise reduced frame as a function of the noise reduced output field and feeding said noise reduced frame back for use in generating a motion compensated frame corresponding to a subsequent field position.
